(19) United States
(12) Patent Application Publication
(10) Pub. No.: US 2015/0267071 A1
(43) Pub. Date: Sep. 24, 2015

(54) RADIATION-CURABLE OPTICALLY CLEAR COATING COMPOSITION FOR TOUCH SENSORS

(71) Applicant: Uni-Pixel Displays, Inc., The Woodlands, TX (US)

(72) Inventors: Danliang Jin, The Woodlands, TX (US); Zhengwei Shi, Spring, TX (US); Xuanqi Zhang, Spring, TX (US); Robert J. Petcavich, The Woodlands, TX (US)

(21) Appl. No.: 14/727,818

(22) Filed: Jun. 1, 2015

Related U.S. Application Data
(63) Continuation-in-part of application No. 14/354,507, filed on Aug. 5, 2014.
Application No. 14/354,507 is a continuation-in-part of application No. 14/354,526, filed on Apr. 25, 2014.
(60) Provisional application No. 61/551,009, filed on Oct. 25, 2011.
(60) Provisional application No. 61/551,030, filed on Oct. 25, 2011.

(51) Int. Cl. C09D 133/00; C09D 175/04; G06F 3/044; C09D 163/10; C09D 187/00; C09D 167/00; C09D 171/00

(52) U.S. Cl. CPC C09D 133/00; C09D 167/00; C09D 175/04; C09D 171/00; C09D 163/10; C09D 187/005; G06F 3/044; G06F 2203/04112; G06F 2203/04111; G06F 2203/04103

(57) ABSTRACT

A radiation-curable optically clear coating composition for patterned deposition on a touch sensor includes a principal resin that includes multi-(meth)acrylate functionalized oligomers or polymers and a free radical-polymerization initiator that includes at least one surface curing agent and at least one deep curing agent.

### CROSS-REFERENCE TO RELATED APPLICATIONS

This application is a continuation-in-part of U.S. patent application Ser. No. 14/354,507, filed on Aug. 5, 2014, which is a national phase entry of PCT International Application PCT/US2012/042050, filed on Jun. 12, 2012, which claims the benefit of, or priority to, U.S. Provisional Patent Application Ser. No. 61/551,009, filed on Oct. 25, 2011, and is also a continuation-in-part of U.S. patent application Ser. No. 14/354,526, filed on Apr. 25, 2014, which is a national phase entry of PCT International Application PCT/US2012/061602, filed on Oct. 24, 2012, which claims the benefit of, or priority to, U.S. Provisional Patent Application Ser. No. 61/551,030, filed on Oct. 25, 2011, all of which are hereby incorporated by reference in their entirety.

### BACKGROUND OF THE INVENTION

A touch screen enabled system allows a user to control various aspects of the system by touch or gestures on the screen. A user may interact directly with one or more objects depicted on a display device by touch or gestures that are sensed by a touch sensor. The touch sensor typically includes a conductive pattern disposed on a transparent substrate configured to sense touch. Touch screens are commonly used in consumer, commercial, and industrial systems.

### BRIEF SUMMARY OF THE INVENTION

According to one aspect of one or more embodiments of the present invention, a radiation-curable optically clear coating composition for patterned deposition on a touch sensor includes a principal resin that includes multi-(meth)acrylate functionalized oligomers or polymers and a free radical-polymerization initiator that includes at least one surface curing agent and at least one deep curing agent.

Other aspects of the present invention will be apparent from the following description and claims.

### BRIEF DESCRIPTION OF THE DRAWINGS

FIG. 1 shows a cross section of a touch screen in accordance with one or more embodiments of the present invention.

FIG. 2 shows a schematic view of a touch screen enabled system in accordance with one or more embodiments of the present invention.

FIG. 3 shows a functional representation of a touch sensor in accordance with one or more embodiments of the present invention.

FIG. 4 shows a cross-section of a touch sensor with conductive patterns disposed on opposing sides of a transparent substrate in accordance with one or more embodiments of the present invention.

FIG. 5A shows a first conductive pattern disposed on a transparent substrate in accordance with one or more embodiments of the present invention.

FIG. 5B shows a second conductive pattern disposed on a transparent substrate in accordance with one or more embodiments of the present invention.

FIG. 5C shows a mesh area of a touch sensor in accordance with one or more embodiments of the present invention.

### DETAILED DESCRIPTION OF THE INVENTION

One or more embodiments of the present invention are described in detail with reference to the accompanying figures. For consistency, like elements in the various figures are denoted by like reference numerals. In the following detailed description of the present invention, specific details are set forth in order to provide a thorough understanding of the present invention. In other instances, well-known features to one of ordinary skill in the art are not described to avoid obscuring the description of the present invention.

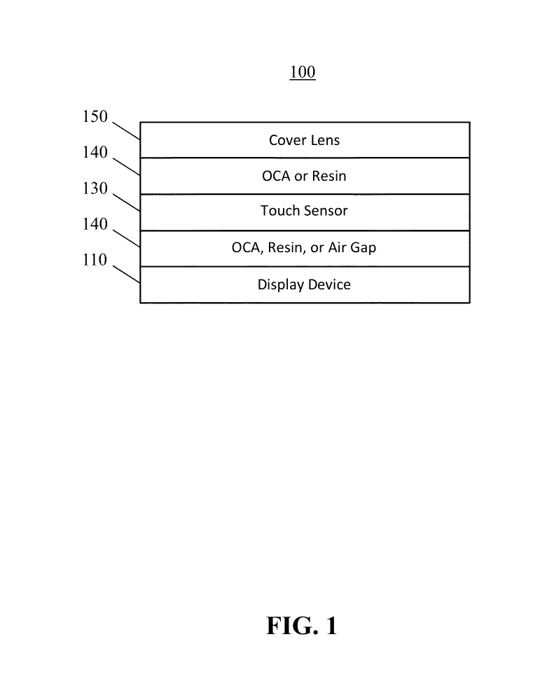

FIG. 1 shows a cross-section of a touch screen 100 in accordance with one or more embodiments of the present invention. Touch screen 100 includes a display device 110 and a touch sensor 130 that overlays at least a portion of a viewable area of display device 110. In certain embodiments, an optically clear adhesive (“OCA”) or optically clear resin (“OCR”) 140 may bond a bottom side of touch sensor 130 to a top, or user-facing, side of display device 110. In other embodiments, an isolation layer or air gap 140 may separate the bottom side of touch sensor 130 from the top, or user-facing, side of display device 110. A transparent cover lens 150 may overlay a top, or user-facing, side of touch sensor 130. The transparent cover lens 150 may be composed of polyester, glass, or any other material suitable for use as a cover lens 150. In certain embodiments, an OCA or OCR 140 may bond a bottom side of the transparent cover lens 150 to the top, or user-facing, side of touch sensor 130. A top side of transparent cover lens 150 faces the user and protects the underlying components of touch screen 100. One of ordinary skill in the art will recognize that the components and/or the stack up of touch screen 100 may vary based on an application or design in accordance with one or more embodiments of the present invention. One of ordinary skill in the art will recognize that touch sensor 130, or the function that it implements, may be integrated into the display device 110 stack up (not independently illustrated) in accordance with one or more embodiments of the present invention.

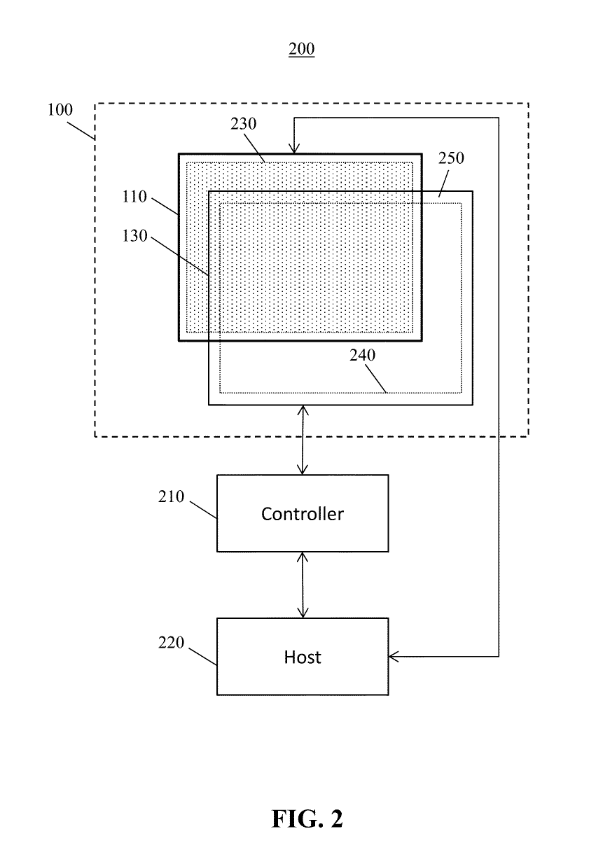

FIG. 2 shows a schematic view of a touch screen enabled system 200 in accordance with one or more embodiments of the present invention. Touch screen enabled system 200 may be a consumer, commercial, or industrial system including, but not limited to, a smartphone, tablet computer, laptop computer, desktop computer, server computer, printer, monitor, television, appliance, application specific device, kiosk, automatic teller machine, copier, desktop phone, automotive display system, portable gaming device, gaming console, or other application or design suitable for use with touch screen 100.

Touch screen enabled system 200 may include one or more printed circuit boards or flexible circuits (not shown) on which one or more processors (not shown), system memory (not shown), and other system components (not shown) may be disposed. Each of the one or more processors may be a single-core processor (not shown) or a multi-core processor (not shown) capable of executing software instructions. Multi-core processors typically include a plurality of processor cores disposed on the same physical die (not shown) or a plurality of processor cores disposed on multiple die (not shown) disposed within the same mechanical package (not shown). System 200 may include one or more input/output devices (not shown), one or more local storage devices (not shown) including solid-state memory, a fixed disk drive, a fixed disk drive array, or any other non-transitory computer readable medium, a network interface device (not shown), and/or one or more network storage devices (not shown) including a network-attached storage device or a cloud-based storage device.

In certain embodiments, touch screen 100 may include touch sensor 130 that overlays at least a portion of a viewable area 230 of display device 110. Touch sensor 130 may include a viewable area 240 that corresponds to that portion of the touch sensor 130 that overlays the light emitting pixels (not shown) of display device 110 (e.g., viewable area 230 of display device 110). Touch sensor 130 may include a bezel circuit 250 outside at least one side of the viewable area 240 that provides connectivity between touch sensor 130 and a controller 210. In other embodiments, touch sensor 130, or the function that it implements, may be integrated into display device 110 (not independently illustrated). Controller 210 electrically drives at least a portion of touch sensor 130. Touch sensor 130 senses touch (capacitance, resistance, optical, acoustic, or other technology) and conveys information corresponding to the sensed touch to controller 210.

The manner in which the sensing of touch is measured, tuned, and/or filtered may be configured by controller 210. In addition, controller 210 may recognize one or more gestures based on the sensed touch or touches. Controller 210 provides host 220 with touch or gesture information corresponding to the sensed touch or touches. Host 220 may use this touch or gesture information as user input and respond in an appropriate manner. In this way, the user may interact with touch screen enabled system 200 by touch or gestures on touch screen 100. In certain embodiments, host 220 may be the one or more printed circuit boards (not shown) or flexible circuits (not shown) on which the one or more processors (not shown) are disposed. In other embodiments, host 220 may be a subsystem (not shown) or any other part of system 200 (not shown) that is configured to interface with display device 110 and controller 210. One of ordinary skill in the art will recognize that the components and the configuration of the components of touch screen enabled system 200 may vary based on an application or design in accordance with one or more embodiments of the present invention.

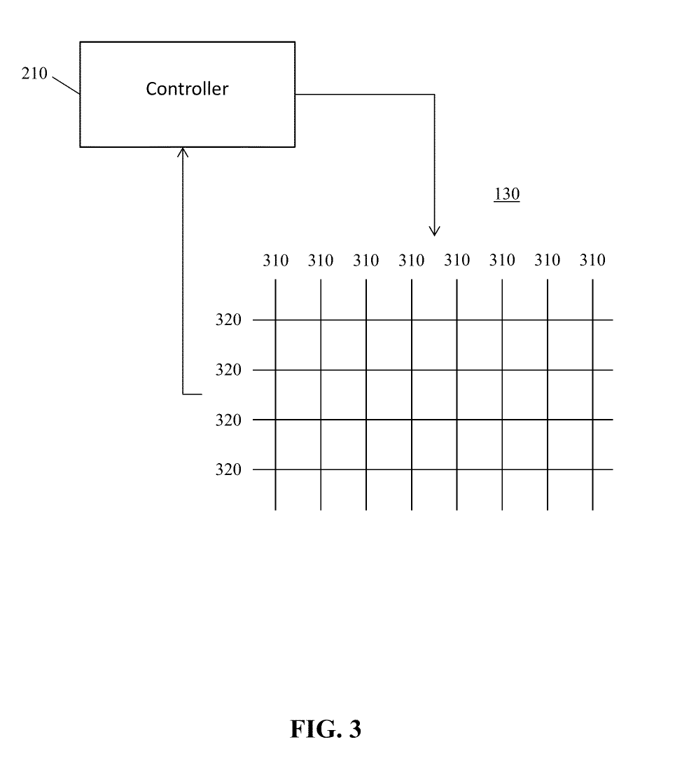

FIG. 3 shows a functional representation of a touch sensor 130 as part of a touch screen (e.g., 100 of FIG. 2) in accordance with one or more embodiments of the present invention. In certain embodiments, touch sensor 130 may be viewed as a plurality of column channels 310 and a plurality of row channels 320. The plurality of column channels 310 and the plurality of row channels 320 may be separated from one another by, for example, a dielectric or substrate (not shown) on which they are disposed. The number of column channels 310 and the number of row channels 320 may or may not be the same and may vary based on an application or a design. The apparent intersections of column channels 310 and row channels 320 may be viewed as uniquely addressable locations of touch sensor 130. In operation, controller 210 may electrically drive one or more row channels 320 and touch sensor 130 may sense touch on one or more column channels 310 that are sampled by controller 210. One of ordinary skill in the art will recognize that the role of row channels 320 and column channels 310 may be reversed such that controller 210 electrically drives one or more column channels 310 and touch sensor 130 senses touch on one or more row channels 320 that are sampled by controller 210.

In certain embodiments, controller 210 may interface with touch sensor 130 by a scanning process. In such an embodiment, controller 210 may electrically drive a selected row channel 320 (or column channel 310) and sample all column channels 310 (or row channels 320) that intersect the selected row channel 320 (or the selected column channel 310) by sensing, for example, changes in capacitance. The change in capacitance may be used to determine the location of the touch or touches. This process may be continued through all row channels 320 (or all column channels 310) such that changes in capacitance are measured at each uniquely addressable location of touch sensor 130 at predetermined intervals. Controller 210 may allow for the adjustment of the scan rate depending on the needs of a particular application or design. In other embodiments, controller 210 may interface with touch sensor 130 by an interrupt driven process. In such an embodiment, a touch or a gesture generates an interrupt to controller 210 that triggers controller 210 to read one or more of its own registers that store sensed touch information sampled from touch sensor 130 at predetermined intervals. One of ordinary skill in the art will recognize that the mechanism by which touch or gestures are sensed by touch sensor 130 and sampled by controller 210 may vary based on an application or a design in accordance with one or more embodiments of the present invention.

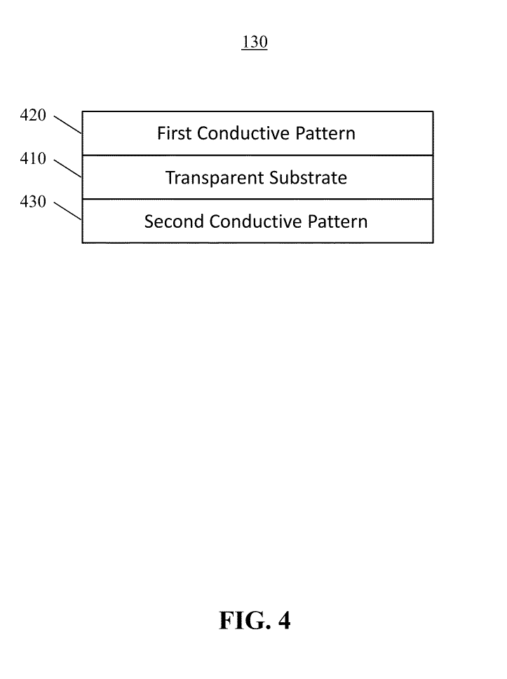

FIG. 4 shows a cross-section of a touch sensor 130 with conductive patterns 420 and 430 disposed on opposing sides of a transparent substrate 410 in accordance with one or more embodiments of the present invention. In certain embodiments, touch sensor 130 may include a first conductive pattern 420 disposed on a top, or user-facing, side of a transparent substrate 410 and a second conductive pattern 430 disposed on a bottom side of the transparent substrate 410. The first conductive pattern 420 and the second conductive pattern 430 may include different, substantially similar, or identical patterns of conductors depending on the application or design. The first conductive pattern 420 may overlay the second conductive pattern 430 at a predetermined alignment that may include an offset. One of ordinary skill in the art will recognize that a conductive pattern may be any shape or pattern of one or more conductors (not shown) in accordance with one or more embodiments of the present invention. One of ordinary skill in the art will also recognize that any type of touch sensor 130 conductor, including, for example, metal conductors, metal mesh conductors, indium tin oxide (“ITO”) conductors, poly(3,4-ethylenedioxythiophene (“PEDOT”) conductors, carbon nanotube conductors, silver nanowire conductors, or any other conductors may be used in accordance with one or more embodiments of the present invention.

One of ordinary skill in the art will recognize that other touch sensor 130 stack ups (not shown) may be used in accordance with one or more embodiments of the present invention. For example, single-sided touch sensor 130 stack ups may include conductors disposed on a single side of a substrate 410 where conductors that cross are isolated from one another by a dielectric material (not shown), such as, for example, as used in On Glass Solution (“OGS”) touch sensor 130 embodiments. Double-sided touch sensor 130 stack ups may include conductors disposed on opposing sides of the same substrate 140 (as shown in FIG. 4) or bonded touch sensor 130 embodiments (not shown) where conductors are disposed on at least two different sides of at least two different substrates 410. Bonded touch sensor 130 stack ups may include, for example, two single-sided substrates 410 bonded together (not shown), one double-sided substrate 410 bonded to a single-sided substrate 410 (not shown), or a double-sided substrate 410 bonded to another double-sided substrate 410 (not shown). One of ordinary skill in the art will recognize that other touch sensor 130 stack ups, including those that vary in the number, type, organization, and/or configuration of substrate(s) and/or conductive pattern(s) are within the scope of one or more embodiments of the present invention. One of ordinary skill in the art will also recognize that one or more of the above-noted touch sensor 130 stack ups may be used in applications where touch sensor 130 is integrated into display device 110 in accordance with one or more embodiments of the present invention.

A conductive pattern 420 or 430 may be disposed on one or more transparent substrates 410 by any process suitable for disposing conductive lines or features on a substrate. Suitable processes may include, for example, printing processes, vacuum-based deposition processes, solution coating processes, or cure/etch processes that either form conductive lines or features on substrate or form seed lines or features on substrate that may be further processed to form conductive lines or features on substrate. Printing processes may include flexographic printing processes, including the flexographic printing of a catalytic ink that may be metallized by an electroless plating process to plate a metal on top of the printed catalytic ink or direct flexographic printing of conductive ink or other materials capable of being flexographically printed, gravure printing, inkjet printing, rotary printing, or stamp printing. Deposition processes may include pattern-based deposition, chemical vapor deposition, electro deposition, epitaxy, physical vapor deposition, or casting. Cure/etch processes may include optical or Ultra-Violet (“UV”)-based photolithography, e-beam/ion-beam lithography, x-ray lithography, interference lithography, scanning probe lithography, imprint lithography, or magneto lithography. One of ordinary skill in the art will recognize that any process or combination of processes, suitable for disposing conductive lines or features on substrate, may be used in accordance with one or more embodiments of the present invention.

With respect to transparent substrate 410, transparent means capable of transmitting a substantial portion of visible light through the substrate suitable for a given touch sensor application or design. In typical touch sensor applications, transparent means transmittance of at least 85 percent of incident visible light through the substrate. However, one of ordinary skill in the art will recognize that other transmittance values may be desirable for other touch sensor applications or designs. In certain embodiments, transparent substrate 410 may be polyethylene terephthalate (“PET”), polyethylene naphthalate (“PEN”), cellulose acetate (“TAC”), cycloaliphatic hydrocarbons (“COP”), polymethylmethacrylates (“PMMA”), polyimide (“PI”), bi-axially-oriented polypropylene (“BOPP”), polyester, polycarbonate, glass, copolymers, blends, or combinations thereof. In other embodiments, transparent substrate 410 may be any other transparent material suitable for use as a touch sensor substrate. One of ordinary skill in the art will recognize that the composition of transparent substrate 410 may vary based on an application or design in accordance with one or more embodiments of the present invention.

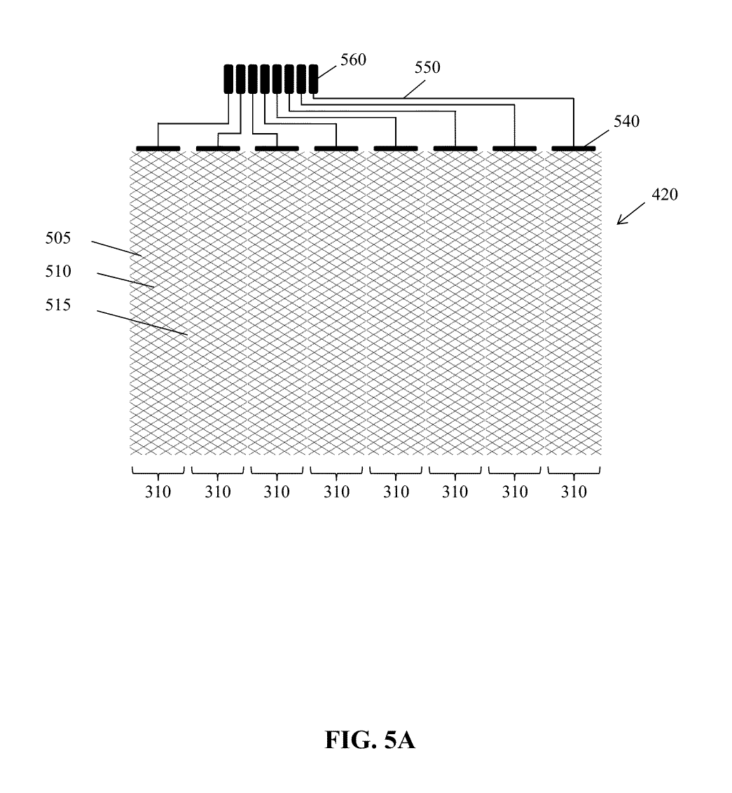

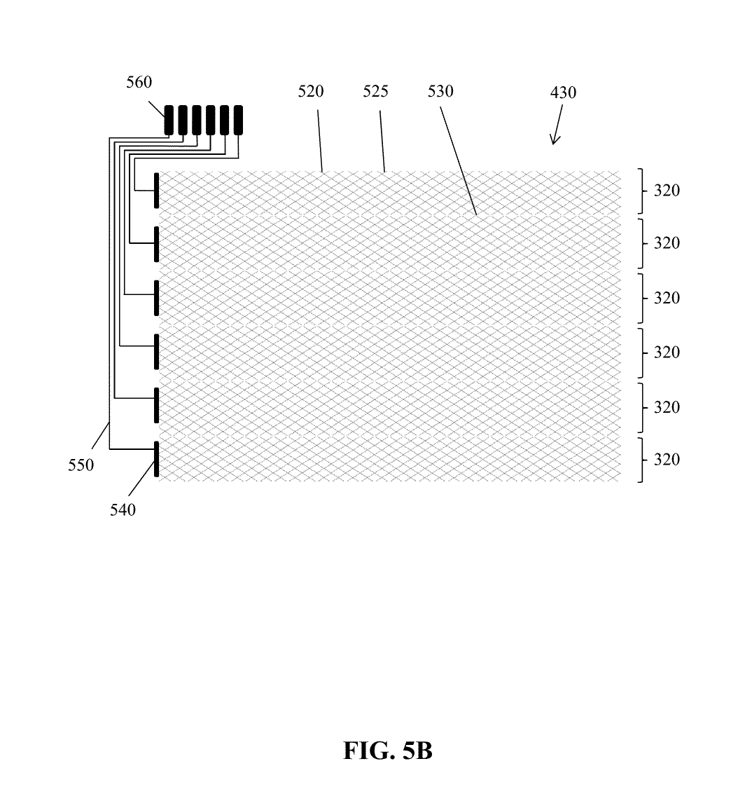

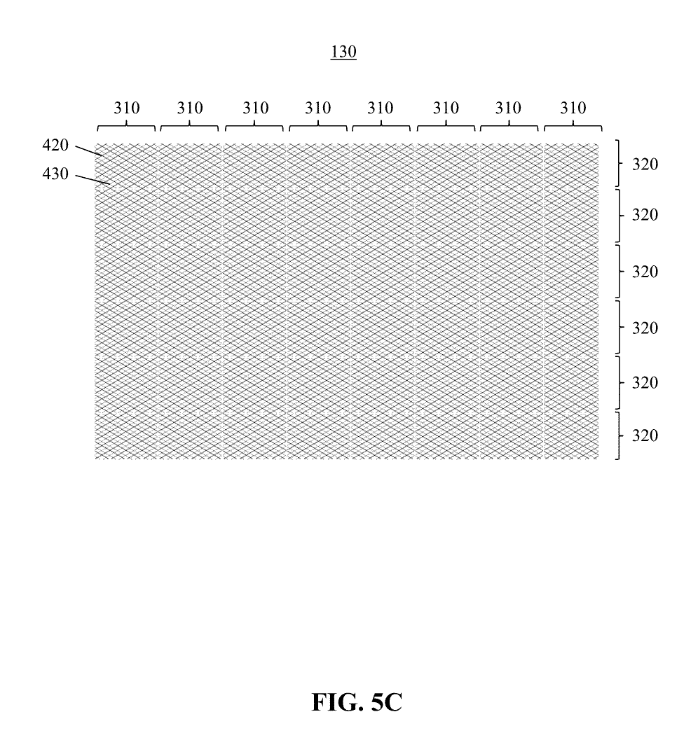

FIG. 5A shows a first conductive pattern 420 disposed on a transparent substrate (e.g., transparent substrate 410) in accordance with one or more embodiments of the present invention. In certain embodiments, first conductive pattern 420 may include a mesh formed by a first plurality of parallel conductive lines oriented in a first direction 505 and a first plurality of parallel conductive lines oriented in a second direction 510 that are disposed on a side of a transparent substrate (e.g., transparent substrate 410). One of ordinary skill in the art will recognize that the number of parallel conductive lines oriented in the first direction 505 and/or the number of parallel conductive lines oriented in the second direction 510 may or may not be the same and may vary based on an application or design. One of ordinary skill in the art will also recognize that a size of first conductive pattern 420 may vary based on an application or a design. In other embodiments, first conductive pattern 420 may include any other shape or pattern formed by one or more conductive lines or features (not independently illustrated). One of ordinary skill in the art will recognize that first conductive pattern 420 is not limited to parallel conductive lines and may comprise any one or more of a predetermined orientation of line segments, a random orientation of line segments, curved line segments, conductive particles, polygons, or any other shape(s) or pattern(s) comprised of electrically conductive material (not independently illustrated) in accordance with one or more embodiments of the present invention.

In certain embodiments, the first plurality of parallel conductive lines oriented in the first direction 505 may be perpendicular (not shown) to the first plurality of parallel conductive lines oriented in the second direction 510, thereby forming a rectangle-type mesh (not shown). In other embodiments, the first plurality of parallel conductive lines oriented in the first direction 505 may be angled relative to the first plurality of parallel conductive lines oriented in the second direction 510, thereby forming a parallelogram-type mesh. One of ordinary skill in the art will recognize that the relative angle between the first plurality of parallel conductive lines oriented in the first direction 505 and the first plurality of parallel conductive lines oriented in the second direction 510 may vary based on an application or a design in accordance with one or more embodiments of the present invention.

In certain embodiments, a first plurality of channel breaks 515 may partition first conductive pattern 420 into a plurality of column channels 310, each electrically isolated from the others (no electrical continuity). One of ordinary skill in the art will recognize that the number of channel breaks 515, the number of column channels 310, and/or the width of the column channels 310 may vary based on an application or design in accordance with one or more embodiments of the present invention. Each column channel 310 may route to a channel pad 540. Each channel pad 540 may route via one or more interconnect conductive lines 550 to an interface connector 560. Interface connectors 560 may provide a connection interface between a touch sensor (e.g., 130 of FIG. 2) and a controller (e.g., 210 of FIG. 2).

FIG. 5B shows a second conductive pattern 430 disposed on a transparent substrate (e.g., transparent substrate 410) in accordance with one or more embodiments of the present invention. In certain embodiments, second conductive pattern 430 may include a mesh formed by a second plurality of parallel conductive lines oriented in a first direction 520 and a second plurality of parallel conductive lines oriented in a second direction 525 that are disposed on a side of a transparent substrate (e.g., transparent substrate 410). One of ordinary skill in the art will recognize that the number of parallel conductive lines oriented in the first direction 520 and/or the number of parallel conductive lines oriented in the second direction 525 may vary based on an application or design. The second conductive pattern 430 may be substantially similar in size to the first conductive pattern 420. One of ordinary skill in the art will recognize that a size of the second conductive pattern 430 may vary based on an application or a design. In other embodiments, second conductive pattern 430 may include any other shape or pattern formed by one or more conductive lines or features (not independently illustrated). One of ordinary skill in the art will also recognize that second conductive pattern 430 is not limited to parallel conductive lines and could be any one or more of a predetermined orientation of line segments, a random orientation of line segments, curved line segments, conductive particles, polygons, or any other shape(s) or pattern(s) comprised of electrically conductive material (not independently illustrated) in accordance with one or more embodiments of the present invention.

In certain embodiments, the second plurality of parallel conductive lines oriented in the first direction 520 may be perpendicular (not shown) to the second plurality of parallel conductive lines oriented in the second direction 525, thereby forming a rectangle-type mesh (not shown). In other embodiments, the second plurality of parallel conductive lines oriented in the first direction 520 may be angled relative to the second plurality of parallel conductive lines oriented in the second direction 525, thereby forming a parallelogram-type mesh. One of ordinary skill in the art will recognize that the relative angle between the second plurality of parallel conductive lines oriented in the first direction 520 and the second plurality of parallel conductive lines oriented in the second direction 525 may vary based on an application or a design in accordance with one or more embodiments of the present invention.

In certain embodiments, a plurality of channel breaks 530 may partition second conductive pattern 430 into a plurality of row channels 320, each electrically isolated from the others (no electrical continuity). One of ordinary skill in the art will recognize that the number of channel breaks 530, the number of row channels 320, and/or the width of the row channels 320 may vary based on an application or design in accordance with one or more embodiments of the present invention. Each row channel 320 may route to a channel pad 540. Each channel pad 540 may route via one or more interconnect conductive lines 550 to an interface connector 560. Interface connectors 560 may provide a connection interface between a touch sensor (e.g., 130 of FIG. 2) and a controller (e.g., 210 of FIG. 2).

FIG. 5C shows a mesh area of a touch sensor 130 in accordance with one or more embodiments of the present invention. In certain embodiments, a touch sensor 130 may be formed, for example, by disposing a first conductive pattern 420 on a top, or user-facing, side of a transparent substrate (e.g., transparent substrate 410) and disposing a second conductive pattern 430 on a bottom side of the transparent substrate (e.g., transparent substrate 410). In other embodiments, a touch sensor 130 may be formed, for example, by disposing a first conductive pattern 420 on a side of a first transparent substrate (e.g., transparent substrate 410), disposing a second conductive pattern 430 on a side of a second transparent substrate (e.g., transparent substrate 410), and bonding the first transparent substrate to the second transparent substrate. One of ordinary skill in the art will recognize that the disposition of the conductive pattern or patterns may vary based on the touch sensor 130 stack up in accordance with one or more embodiments of the present invention. In embodiments that use two conductive patterns, the first conductive pattern 420 and the second conductive pattern 430 may be offset vertically, horizontally, and/or angularly relative to one another. The offset between the first conductive pattern 420 and the second conductive pattern 430 may vary based on an application or a design. One of ordinary skill in the art will recognize that the first conductive pattern 420 and the second conductive pattern 430 may be disposed on substrate or substrates 410 using any process or processes suitable for disposing the conductive patterns on the substrate or substrates 410 in accordance with one or more embodiments of the present invention.

In certain embodiments, the first conductive pattern 420 may include a first plurality of parallel conductive lines oriented in a first direction (e.g., 505 of FIG. 5A) and a first plurality of parallel conductive lines oriented in a second direction (e.g., 510 of FIG. 5A) that form a mesh that is partitioned by a first plurality of channel breaks (e.g., 515 of FIG. 5A) into electrically partitioned column channels 310. In certain embodiments, the second conductive pattern 430 may include a second plurality of parallel conductive lines oriented in a first direction (e.g., 520 of FIG. 5B) and a second plurality of parallel conductive lines oriented in a second direction (e.g., 525 of FIG. 5B) that form a mesh that is partitioned by a second plurality of channel breaks (e.g., 530 of FIG. 5B) into electrically partitioned row channels 320. In operation, a controller (e.g., 210 of FIG. 2) may electrically drive one or more row channels 320 (or column channels 310) and touch sensor 130 senses touch on one or more column channels 310 (or row channels 320). In other embodiments, the disposition and/or the role of the first conductive pattern 420 and the second conductive pattern 430 may be reversed.

In certain embodiments, one or more of the plurality of parallel conductive lines oriented in the first direction (e.g., 505 of FIG. 5A, 520 of FIG. 5B) and one or more of the plurality of parallel conductive lines oriented in the second direction (e.g., 510 of FIG. 5A, 525 of FIG. 5A) may have a line width that varies based on an application or design, including, for example, nanometer or micrometer-fine line widths. In addition, the number of parallel conductive lines oriented in the first direction (e.g., 505 of FIG. 5A, 520 of FIG. 5B), the number of parallel conductive lines oriented in the second direction (e.g., 510 of FIG. 5A, 525 of FIG. 5B), and the line-to-line spacing between them may vary based on an application or a design. One of ordinary skill in the art will recognize that the size, configuration, and design of each conductive pattern 420, 430 may vary based on an application or a design in accordance with one or more embodiments of the present invention. One of ordinary skill in the art will also recognize that touch sensor 130 depicted in FIG. 5C is illustrative but not limiting and that the size, shape, and design of the touch sensor 130 is such that there is substantial transmission of an image (not shown) of an underlying display device (e.g., 110 of FIG. 1) in actual use that is not shown in the drawing.

From a logistical standpoint, touch sensors may, for example, be manufactured in one location, stored in another location, and integrated with display devices into touch screens at yet another location. As such, subsequent to fabrication, but prior to integration, bare touch sensors must be protected from handling and environmental exposure to ensure that they are not damaged and function as intended when finally integrated into touch screens. Common failure modes associated with environmental exposure, handling, and use include oxidation and scratching that may result in optical or electrical defects that reduce yield and/or long term reliability. In terms of optical defects, conductive material of one or more conductive patterns, or the transparent substrate on which they are disposed, may be oxidized by environmental exposure that render portions of the one or more conductive patterns or the transparent substrate itself more visibly apparent by drawing the user's eye to the discolored oxidized portions. In addition, scratching of one or more conductive patterns, or the transparent substrate on which they are disposed, may optically distort the image of the underlying display device that is intended to be transmitted through the touch sensor. In terms of electrical defects, oxidation of conductive material may result in unintended electrical opens or shorts that render the touch sensor inoperable for its intended touch sensing purpose. In addition, scratching may physically damage one or more conductive lines or features of one or more conductive patterns of a touch sensor that may also result in unintended electrical opens or shorts that render the touch sensor inoperable for its intended touch sensing purpose.

Conventional methods to address issues related to environmental exposure, handling, and use include passivation of the conductive material during fabrication, the use of liners to protect the conductive patterns of a bare touch sensor prior to integration, and the application of a laminated protective layer to protect the conductive pattern disposed on the back side of the touch sensor when integrated. With respect to passivation, one or more conductive patterns of a touch sensor may be passivated to protect the conductive material from oxidation. Passivation processes include the deposition of an additional metal layer on the conductive material. With respect to liners, a liner is disposed over a conductive pattern to protect the conductive pattern from oxidation and scratching. The liners are thin planar sheets of flexible material, typically composed of polypropylene, which are tacky such that they stick to the planar surfaces of the touch sensor where the conductive patterns are disposed. Typically, at least two liners are required for a bare touch sensor, one placed over a first conductive pattern disposed on a front side of a touch sensor and another placed over a second conductive pattern disposed on a back side of the touch sensor. With respect to a laminated protective layer, when a touch sensor is integrated into a touch screen, the back side of the touch sensor is prone to scratching and other failure modes from contact with the components of the underlying display device. A protective layer is typically laminated to the back side of the touch sensor to protect the conductive pattern disposed thereon from scratching and other failure modes.

However, the conventional methods of protecting a touch sensor have a number of shortcomings that are problematic in a high-volume manufacturing environment and in a distributed manufacturing process where various stages of manufacturing are performed at different locations. While passivation provides a number of benefits, it requires additional process steps and additional material that increases the time and the cost required to fabricate a touch sensor. In addition, subsequent to the application of passivating material, removal of residual material is difficult, time consuming, and often damages one or more conductive patterns of a touch sensor. While liners provide protection for one or more conductive patterns of a bare touch sensor, when a liner is removed, the tackiness of the liner often causes peeling of conductive material off the transparent substrate rendering the touch sensor inoperable for its intended touch sensing purpose. In addition, residual material from the liner often causes cosmetic or optical defects that prevent the transmission of the image of the underlying display device at an acceptable quality level. While the laminated protective layer protects the conductive pattern disposed on the back side of the touch sensor in use, the additional protective layer and the optically clear adhesive that is used to laminate it in place increase the haze of the touch sensor, thereby reducing the optical display quality of the touch screen.

Accordingly, in one or more embodiments of the present invention, a radiation-curable optically clear coating composition for touch sensors provides protection from environmental exposure and handling prior to integration and provides protection for the touch sensor in use after integration in a more cost efficient manner, which is easier to implement, provides better optical results, improves yield, and improves long-term reliability over conventional methods. The optically clear coating composition provides protection from scratching, oxidation, and eliminates the needs for liners used with bare touch sensors or laminated protective layers used to protect integrated touch sensors. Moreover, the optically clear coating composition may be applied through a roll-to-roll or other deposition processes that allows for the precise, or patterned, deposition of the optically clear coating composition on one or both sides of a touch sensor. For example, the optically clear coating composition may be applied in a precise pattern corresponding to the pattern of the conductive patterns, leaving the transparent portions of the transparent substrate free from coating.

In one or more embodiments of the present invention, a radiation-curable optically clear coating composition provides protection from environmental exposure and handling during the touch sensor integration process where a bare touch sensor is integrated with a display device into a touch screen. The radiation-curable optically clear coating composition protects the one or more conductive patterns as well as the transparent substrate on which they are disposed from scratching in a manner that passivation, liners, and a back side laminated protective layer cannot. As such, the optically clear coating composition reduces the number of optical and electrical defects that plague traditional touch sensors during the integration process and in subsequent use. In addition, in one or more embodiments of the present invention, a method of applying a radiation-curable optically clear coating composition allows for the use of a flexographic printing process or other deposition processes to deposit an optically clear coating composition, and potentially other coatings, in a precise pattern that can potentially be applied to both sides at the same time.

In developing a radiation-curable optically clear coating composition of the present invention, conventional coating compositions were analyzed. Conventional coating compositions used in general-purpose applications that require some measure of scratch and abrasion resistance typically employ a cross-linked polymer-based molecular structure. A cross-link is a bond, covalent or ionic, that links one monomer or polymer to another. Cross-linked polymer structures are linked together in a three-dimensional structure that increases the intermolecular forces, usually covalent bonds, within the polymer chains and limits polymeric chain relaxation. Compared to a linear polymer structure, where monomers with dual functional groups are joined together in a chain, the scratch resistance of a cross-linked polymer may be dictated by the cross-linking density. The cross-linking density refers to the percentage of cross-linked bonds within a given polymer. While cross-linked polymer structures provide improved scratch resistance over linear polymer structures, the use of conventional coatings based on cross-linked polymer structures presents a number of issues that impede their effective use.

Conventional coating compositions typically require a tradeoff, or at least a compromise, between flexibility and hardness. In applications or designs that require a high degree of hardness for scratch resistance, the applied coating tends to be inflexible, brittle, and susceptible to breakage. Alternatively, in applications or designs that require a high degree of flexibility to resist breakage, the applied coating is prone to scratching. In addition, conventional coating compositions typically exhibit shrinkage after curing by, for example, exposure to UV radiation. In applications or designs that apply the coating to substrates with low mechanical strength such as, for example, flexible PET substrates used in touch sensor applications, the shrinkage of the cured coating gives rise to undesirable curling of the substrate. In addition, conventional coating compositions are difficult to apply for a number of reasons. While materials with low density cross-linked networks are viscous and behave as a liquid-like gel, materials with high density cross-linked networks are very rigid in their solid state. As such, while it is desirable to apply the coating composition in a liquid state, it is necessary to form the high density of cross-linking after application of the liquid coating composition to the substrate. Thus, the density of cross-linking is constrained by the effectiveness of the curing process after application of the coating to the substrate. Moreover, the application of conventional coating compositions may not be possible, or is at least made very difficult, using conventional solution-based application processes. This is due to the fact that cross-linked polymers cannot dissolve in any solvent and only swell when placed in solvent. This is problematic because coating compositions typically have to be in a liquid state to allow molecules to move and react in an efficient manner.

As such, conventional coating compositions require trade-offs in various properties that render the coating inefficient or incapable of serving their intended purpose that increase the difficulty and cost of manufacturing and negatively impact yield and long-term reliability. Thus, conventional coating compositions are not suitable for protecting a bare touch sensor from environmental exposure and handling prior to integration nor as an alternative to a back side laminated protective layer.

Conventional UV-curable coating compositions containing a (meth)acrylate compound as a principal resin are sometimes used as protective films because the cured coating provides some manner of transparency, mechanical strength, and scratch resistance. However, conventional UV-curable coating compositions are composed of a cation radiation curable resin and a cation polymerization initiator which generates a cation when irradiated with UV radiation. In some cases, inorganic particles are included to increase the mechanical strength, pencil hardness, and scratch resistance. As such, conventional UV-curable coating compositions are not suitable for protecting a bare touch sensor from environmental exposure and handling prior to integration nor as an alternative to a back side laminated protective layer.

Conventional UV-curable coating compositions based on radical-polymerization mechanisms are uncommon and have received less attention because they are very difficult to process and cure. Specifically, in thin-film applications, curing effectiveness is inhibited by the presence of oxygen and nitrogen sealing or other means of preventing oxidation are required to cure at even modest levels of effectiveness. While progress has been made in developing conventional UV-curable coating compositions based on radical-polymerization mechanisms, a number of issues continue to impede their widespread adoption and use. For example, conventional UV-curable coating compositions based on radical-polymerization lack flexibility due to built-in stress, are fragile, and exhibit poor process-ability in a manufacturing environment. As such, they too, are not suitable for protecting a bare touch sensor from environmental exposure and handling prior to integration nor as an alternative to a back side laminated protective layer.

Accordingly, in one or more embodiments of the present invention, a radiation-curable optically clear coating composition provides a transparent coat that provides well-balanced flexibility and hardness, a high degree of scratch and abrasion resistance, and improved adhesiveness, radiation curing stability, and process-ability in a manufacturing environment, including, for example, touch sensor applications. The radiation-curable optically clear coating composition facilitates all aspects of manufacturing including application, processing, and post-fabrication processing and improves yield while reducing costs.

In one or more embodiments of the present invention, a radiation-curable optically clear coating composition is a coating that, when cured by radiation, forms a three-dimensional cross-linked network through a free-radical polymerization mechanism. The radiation-curable optically clear coating composition includes a principal resin that includes multi-(meth)acrylate functionalized oligomers or polymers and a free radical-polymerization initiator, as a curing agent, that generates a highly reactive species when exposed to radiation. The photo-initiators contains multiple components including one or more surface curing agents and one or more deep curing agents that improve curing efficiency and provide homogenous curing along the depth of the applied coating. In addition, in some embodiments, a solvent may optionally be included that enables the manufacture of the radiation-curable optically clear coating composition in a manner that is fast, efficient, and cost effective to apply, process, and process post-fabrication.

As the principal resin, a multi-(meth)acrylate functionalized oligomers or polymers resin may be used as a film-forming component to provide the basic properties of the cured coating. Compared to small molecules, oligomers or polymers are relatively large molecules which are obtained by chemically linking tens to thousands of relatively small molecules. Specifically, multi-(meth)acrylate functionalized oligomers or polymers typically have a molecular weight in a range between 500 and 20,000 and possess between 2 and 15 acrylate functional groups per molecule. As a result, a high degree of cross-linking may be achieved for improved hardness. The multi-(meth)acrylate functionalized oligomers or polymers may be derived from various chemical backbones, such as, for example, polyol, polyester, polyurethane, polyether, epoxies, and acrylics. In terms of molecular geometry, they may be linear or branched. Because of the skeleton of the resin backbone and the molecular geometry, these multi-(meth)acrylate functionalized oligomers or polymers are highly viscous liquids with a viscosity in a range between at least a few thousand centipoises and potentially greater than one million centipoises in a broad temperature window.

Pentaerithritol tetraacrylate (“PETA”) is a commonly used UV-curable resin because it provides a high degree of cross-linking in the cured coating due to the relatively large ratio of (meth)acrylate functionality over the molecular weight. As such, it has been employed for protective coatings in various applications, including display applications where it provides a high degree of scratch resistance. However, PETA resins exhibit significant volumetric shrinkage during curing due to its intrinsic molecular structure. This presents a number of issues including, for example, a high degree of undesirable curling and brittleness. In contrast, a radiation-curable hard-coat composition that includes multi-(meth) acrylate functionalized oligomers or polymers as a principal resin may use a limited amount of PETA, if it uses any at all, as a complimentary component to provide additional cross-linking density. Because of the unique molecular characteristics noted herein, the multi-(meth)acrylate functionalized oligomers or polymers exhibit a substantially smaller amount of shrinkage, less than 5 percent by volume, after radiation curing. As such, a low level of built-in stress is induced in the coating resulting in a small curling angle after radiation curing. In addition, because of the multi-functionality of the (meth)acrylate functionalized oligomers or polymers used, the cross-linking density is very high after curing.

In one or more embodiments of the present invention, in a radiation-curable hard-coat composition, the principal resin content as a percentage of weight of the composition may be in a range between 5 percent and 96 percent. In one or more embodiments of the present invention, the principal resin may include one or more of 1,3-butylene glycol di(meth)acrylate, 1,4-butanediol di(meth)acrylate, 1,6 hexanediol di(meth)acrylate, alkoxylated aliphatic diacrylate, alkoxylated neopentyl glycol di(meth)acrylate, cyclohexane dimethanol di(meth)acrylate, diethylene glycol di(meth)acrylate, dipropylene glycol di(meth)acrylate, ethoxylated bisphenol a di(meth)acrylate, ethylene glycol di(meth)acrylate, neopentyl glycol dimethacrylate, polyester diacrylate, polyethylene glycol di(meth)acrylate, polypropylene glycol di(meth)acrylate, propoxylated neopentyl glycol diacrylate, tricyclodecane dimethanol diacrylate, triethylene glycol di(meth)acrylate, tripropylene glycol di(meth)acrylate, di-trimethylolpropane tetraacrylate, dipentaerythritol pentaacrylate, ethoxylated pentaerythritol tetraacrylate, dipentaerythritol pentaacrylate, which may also be low viscosity dipentaerythritol pentaacrylate, pentaacrylate ester, pentaerythritol tetraacrylate, ethoxylated trimethylolpropane triacrylate, ethoxylated trimethylolpropane triacrylate, ethoxylated trimethylolpropane triacrylate, highly propoxylated glyceryl triacrylate, trimethylolpropane triacrylate, which may also be low viscosity trimethylolpropane triacrylate, pentaerythritol triacrylate, propoxylated glyceryl triacrylate, propoxylated trimethylolpropane triacrylate, trimethylolpropane trimethacrylate, tris(2-hydroxy ethyl) isocyanurate tri(meth)acrylate, 2(2-ethoxyethoxy) ethyl acrylate, 2-phenoxyethyl methacrylate, 3,3,5 trimethylcyclohexyl methacrylate, alkoxylated lauryl acrylate, alkoxylated phenol acrylate, alkoxylated tetrahydrofurfuryl acrylate, caprolactone acrylate, cyclic trimethylolpropane formal acrylate, cycloaliphatic acrylate monomer, dicyclopentadienyl methacrylate, diethylene glycol methyl ether methacrylate, ethoxylated (4) nonyl phenol methacrylate, ethoxylated nonyl phenol acrylate, isobornyl methacrylate, isodecyl methacrylate, isooctyl acrylate, lauryl methacrylate, methoxy polyethylene glycol monomethacrylate, octyldecyl acrylate, stearyl methacrylate, tetrahydrofurfuryl methacrylate, tridecyl methacrylate, and/or triethylene glycol ethyl ether methacrylate.

The cross-linking density of cross-linked polymers may be dictated by the effectiveness of the radiation curing. As such, photo-initiators play a critically important role in a radiation-curable coating composition. A photo initiator is a compound especially added to a composition to convert absorbed light energy, UV radiation or visible light, into chemical energy in the form of an initiating species, such as, for example, free radicals. The free radical-polymerization initiator of the radiation-curable optically clear coating composition are a set of compounds that generate a free radical when irradiated with radiation to initiate polymerization. For photo initiation to proceed efficiently the absorption bands of the photo initiator must overlap with the emission spectrum of the source and there must be minimal competing absorption by the components of the coating composition at the wavelengths corresponding to photo initiator excitation, or a combination of photo initiators, co-photo initiators, and sensitizers. As discussed below, if e-beam curing is used as the curing mechanism, a photo-initiator may not be used.

The photo initiator is an essential ingredient of radiation-curable coatings and has to have as much absorption as possible in the 200 nanometer to 480 nanometer range, in addition to other characteristics such as high reactivity and high thermal stability. Because of the intrinsic chemical structure of the radiation-curable optically clear coating composition, any single photo initiator is not sufficient to cover a sufficiently broad spectrum range that provides sufficient energy absorption for efficient curing in a given irradiation cycle. As such, in one or more embodiments of the present invention, instead of a mono-constituent photo initiator, a combination of at least two photo initiators, one for deep curing and another for surface curing, may be used to cover the full UV spectrum and provide efficient curing in at little as one UV irradiation cycle.

In one or more embodiments of the present invention, in a radiation-curable hard-coat composition, the free radical-polymerization initiator content as a percentage of weight of the composition may be in a range between 0.5 percent and 10 percent. In one or more embodiments of the present invention, the free radical-polymerization initiator may include at least two of acetophenone, anisoin, anthraquinone, anthraquinone-2-sulfonic acid, sodium salt monohydrate, (benzene) tricarbonylchromium, benzil, benzoin, benzoin ethyl ether, benzoin isobutyl ether, benzoin methyl ether, benzophenone, benzophenone/1-hydroxycyclohexyl phenyl ketone, 50/50 blend, 3,3′,4,4′-benzophenonetetracarboxylic dianhydride, 4-benzoylbiphenyl, 2-benzyl-2-(dimethylamino)-4′-morpholinobutyrophenone, 4,4′-bis(diethylamino)benzophenone, 4,4′-bis(dimethylamino)benzophenone, camphorquinone, 2-chlorothioxanthen-9-one, (cumene)cyclopentadienyliron(ii) hexafluorophosphate, dibenzosuberenone, 9,10-diethoxy and 9,10-dibutoxyanthracene, 2,2-diethoxyacetophenone, 4,4′-dihydroxybenzophenone, 2,2-dimethoxy-2-phenylacetophenone, 4-(dimethylamino)benzophenone, 4,4′-dimethylbenzil, 2,5-dimethylbenzophenone, 3,4-dimethylbenzophenone, diphenyl(2,4,6-trimethylbenzoyl)phosphine oxide/2-hydroxy-2-methylpropiophenone, 50/50 blend, 4′-ethoxyacetophenone, 2-ethylanthraquinone, 2-ethyl-9,10-dimethoxyanthracene, ferrocene, 3′-hydroxyacetophenone, 4′-hydroxyacetophenone, 3-hydroxybenzophenone, 4-hydroxybenzophenone, 1-hydroxycyclohexyl phenyl ketone, 2-hydroxy-2-methylpropiophenone, isopropylthioxanthone, 2-methylbenzophenone, 3-methylbenzophenone, methybenzoylformate, 2-methyl-4′-(methylthio)-2-morpholinopropiophenone, phenanthrenequinone, 4′-phenoxyacetophenone, and thioxanthen-9-one.

In one or more embodiments of the present invention, the radiation-curable optically clear coating composition may optionally include a solvent. The optional solvent may be used to regulate viscosity and wetting property of the principal resin as applied to, for example, a transparent substrate of a touch sensor. The solvent may include ketone-type solvents such as acetone, methyl ethyl ketone, and iso-butyl ethyl ketone, alcohol-type solvents such as epoxy ethanol and methoxy ethanol, and benzene-based solvents such as toluene. The addition of a solvent does not adversely affect the scratch resistant properties of the radiation-curable optically clear coating composition because it evaporates after the coating is disposed on substrate and the substrate is cured at temperature.

In one or more embodiments of the present invention, various combinations of the above-noted components may be used to create a radiation-curable optically clear coating composition that exhibit different degrees of the various characteristics of the coating composition. While a few exemplary combinations are provided herein, one of ordinary skill in the art, having the benefit of this disclosure, will recognize that other combinations may be used in accordance with one or more embodiments of the present invention.

In certain embodiments, a radiation-curable optically clear coating composition may include a principal resin comprising multi-(meth)acrylate functionalized oligomers or polymers, a free radical-polymerization initiator comprising at least one surface curing agent and at least one deep curing agent, and does not require the use of any solvent. The principal resin may comprise aliphatic urethane acrylate oligomer content in a range between 5 percent and 10 percent as a percentage of the total weight of the composition, PETA content in a range between 60 percent and 70 percent as a percentage of the total weight of the composition, 1,6 hexanediol di(meth)acrylate content in a range between 18 percent and 22 percent as a percentage of the total weight of the composition, and acryloxy terminated ethyleneoxide-dimethylsiloxane-ethyleneoxide ABA block copolymer content in a range between 0.01 percent and 1 percent as a percentage of the total weight of the composition. The free radical-polymerization initiator may comprise at least a surface curing agent and a deep curing agent that provide absorption in a range between 200 nanometers and 480 nanometers, for example, a surface curing agent content, 1-hydroxycyclohexyl phenyl ketone, in a range between 5 percent and 10 percent as a percentage of the total weight of the composition and a deep curing agent content, diphenyl(2,4,6-trimethylbenzoyl)phosphine oxide, in a range between 0.5 percent and 1.5 percent as a percentage of the total weight of the composition. This composition provides high curing efficiency.

In other embodiments, a radiation-curable optically clear coating composition may include a principal resin comprising multi-(meth)acrylate functionalized oligomers or polymers, a free radical-polymerization initiator comprising at least one surface curing agent and at least one deep curing agent, and does not require the use of any solvent. The principal resin may comprise aliphatic urethane acrylate oligomer content in a range between 2 percent and 10 percent as a percentage of the total weight of the composition and PETA content in a range between 50 percent and 70 percent as a percentage of the total weight of the composition. The free radical-polymerization initiator may comprise four curing agents that provide absorption in a range between 200 nanometers and 480 nanometers, for example, a surface curing agent content, 1-hydroxycyclohexyl phenyl ketone, in a range between 1 percent and 10 percent as a percentage of the total weight of the composition, a deep curing agent content, diphenyl(2,4,6-trimethylbenzoyl)phosphine oxide, in a range between 0.5 percent and 6 percent as a percentage of the total weight of the composition, a deeper curing agent content, isopropylthioxanthone, in a range between 0.2 percent and 2 percent as a percentage of the total weight of the composition, and a medium curing agent content, 2-methyl-4′-(methylthio)-2-morpholinopropiophenone, in a range between 1 percent and 5 percent of the total weight of the composition. This composition provides broader absorption spectrum and is more sensitive to UV exposure.

In still other embodiments, a radiation-curable optically clear coating composition may include a principal resin comprising multi-end-capped (meth)acrylate oligomers or polymers, a free radical-polymerization initiator comprising at least one surface curing agent and at least one deep curing agent, and a solvent. The principal resin may comprise aliphatic urethane acrylate oligomer content in a range between 10 percent and 80 percent as a percentage of the total weight of the composition and PETA content in a range between 10 percent and 80 percent as a percentage of the total weight of the composition. The free radical-polymerization initiator may comprise at least a surface curing agent and a deep curing agent that provide absorption in a range between 200 nanometers and 480 nanometers, for example, a surface curing agent content, 1-hydroxycyclohexyl phenyl ketone, in a range between 1 percent and 10 percent as a percentage of the total weight of the composition and a medium depth curing agent content, 2-methyl-4′-(methylthio)-2-morpholinopropiophenone, in a range between 1 percent and 5 percent as a percentage of the total weight of the composition. The solvent may comprise cyclopentanone content in a range between 10 percent and 70 percent as a percentage of the total weight of the composition. This composition includes solvent which has the flexibility to reduce solution viscosity and reduce coating thickness in a broader range.

In one or more embodiments of the present invention, a radiation-curable optically clear coating composition may be applied with a patterning process including, for example, roll-to-roll flexographic printing, gravure printing, reverse-gravure printing, offset printing, inkjet printing, and slot-die coating processes.

Advantages of one or more embodiments of the present invention may include one or more of the following:

In one or more embodiments of the present invention, a radiation-curable optically clear coating composition provides protection against environmental exposure and handling prior to touch sensor integration.

In one or more embodiments of the present invention, a radiation-curable optically clear coating composition may be used instead of passivation processes to protect the one or more conductive patterns of a touch sensor from scratching and oxidation.

In one or more embodiments of the present invention, a radiation-curable optically clear coating composition may be used instead of liners used to protect bare touch sensors from scratching and oxidation after fabrication, but prior to integration into touch screens.

In one or more embodiments of the present invention, a radiation-curable optically clear coating composition provides back side protection for a touch sensor during use after integration into a touch screen.

In one or more embodiments of the present invention, a radiation-curable optically clear coating composition may be used instead of a laminated protective layer to protect a back side of a touch sensor from scratching during use after integration. The elimination of the laminated protective layer and optically clear adhesive used to secure it in place reduces the haze and improves the optical transmission qualities of the touch sensor.

In one or more embodiments of the present invention, a radiation-curable optically clear coating composition includes a principal resin comprising multi-end-capped (meth)acrylate oligomers or polymers that are highly viscous.

In one or more embodiments of the present invention, a radiation-curable optically clear coating composition includes a free radical-polymerization that includes at least one surface curing agent and at least one deep curing agent that allows for sufficient curing in a single irradiation cycle.

In one or more embodiments of the present invention, a radiation-curable optically clear coating composition may or may not use solvents depending on an application or design.

While the present invention has been described with respect to the above-noted embodiments, those skilled in the art, having the benefit of this disclosure, will recognize that other embodiments may be devised that are within the scope of the invention as disclosed herein. Accordingly, the scope of the invention should be limited only by the appended claims.

What is claimed is:

1. A radiation-curable optically clear coating composition for patterned deposition on a touch sensor comprising:
a principal resin comprising multi-(meth)acrylate functionalized oligomers or polymers; and
a free radical-polymerization initiator comprising at least one surface curing agent and at least one deep curing agent.

2. The composition of claim 1, where at least one multi-(meth)acrylate functionalized oligomers or polymers is at least 4 functional groups of the principal resin.

3. The composition of claim 1, wherein principal resin content as a percentage of weight of the composition is in a range between 5 percent and 96 percent.

4. The composition of claim 1, wherein free radical-polymerization initiator content as a percentage of weight of the composition is in a range between 0.5 percent and 10 percent.

5. The composition of claim 1, further comprising a solvent.

6. The composition of claim 5, wherein solvent content as a percentage of weight of the composition is in a range between 10 percent and 70 percent.

7. The composition of claim 1, wherein the principal resin has a molecular weight in a range between 500 and 20000.

8. The composition of claim 1, wherein the principal resin comprises a number of acrylate functional groups in a range between 2 and 15 acrylate functional groups per molecule.

9. The composition of claim 1, wherein the principal resin has a linear molecular geometry.

10. The composition of claim 1, wherein the principal resin has a branched molecular geometry.

11. The composition of claim 1, wherein the principal resin has a viscosity in a range between 1000 centipoises and 1 million centipoises.

12. The composition of claim 1, wherein the multi-(meth)acrylate functionalized oligomers or polymers are derived from a polyol backbone.

13. The composition of claim 1, wherein the multi-(meth)acrylate functionalized oligomers or polymers are derived from a polyester backbone.

14. The composition of claim 1, wherein the multi-(meth)acrylate functionalized oligomers or polymers are derived from a polyurethane backbone.

15. The composition of claim 1, wherein the multi-(meth)acrylate functionalized oligomers or polymers are derived from a polyether backbone.

16. The composition of claim 1, wherein the multi-(meth)acrylate functionalized oligomers or polymers are derived from an epoxy backbone.

17. The composition of claim 1, wherein the multi-(meth)acrylate functionalized oligomers or polymers are derived from an acrylic backbone.

18. The composition of claim 1, wherein the free radical-polymerization initiator comprises 1-hydroxycyclohexyl phenyl ketone and diphenyl(2,4,6-trimethylbenzoyl)phosphine oxide.

19. The composition of claim 1, wherein the free radical-polymerization initiator generates a highly reactive species when exposed to UV radiation.

20. The composition of claim 5, wherein the solvent comprises a keytone-based solvent including acetone, methyl ethyl ketone, or iso-butyl ethyl ketone.

21. The composition of claim 5, wherein the solvent comprises an alcohol-based solvent including ethoxy alcohol or methoxy ethanol.

22. The composition of claim 5, wherein the solvent comprises a benzene-based solvent including toluene.
